(19) United States
(12) Patent Application Publication
(10) Pub. No.: US 2008/0189286 A1
(43) Pub. Date: Aug. 7, 2008

(54) System For Managing And Protecting Personal Information On Internet And Method Thereof

(76) Inventors: Dae Seon Choi, Daejon (KR); Jong Hyouk Noh, Daejon (KR); Taesung Kim, Daejon (KR); Seung Hyun Kim, Daegu (KR); Sang Rae Cho, Daejon (KR); Yeong Sub Cho, Daejon (KR); Seung Hun Jin, Daejon (KR)

Correspondence Address: LADAS & PARRY LLP, 224 SOUTH MICHIGAN AVENUE, SUITE 1600, CHICAGO, IL, 60604, US

(21) Appl. No.: 11/721,701

(22) PCT Filed: May 17, 2005
(86) PCT No.: PCT/KR05/01433

§ 371 Date: Jun. 14, 2007

(30) Foreign Application Priority Data
Dec. 21, 2004 (KR) 10-2004-0109131

(51) Int. Cl. G06F 7/06; G06F 17/30

(52) U.S. Cl. 707/9; 707/3; 707/E17.009

(57) ABSTRACT

A system for managing and protecting personal information on the Internet and a method thereof are disclosed. The management and the access control of the personal information stored in a plurality of ID management servers that store and provide the personal information of users are performed using an Identity search server and a personal information protection server, and thus the convenience in use can be provided to the users who manage the personal information with the protection of the personal information through the access control of the personal information.

### TECHNICAL FIELD

The present invention relates to a system for managing and protecting personal information on the Internet and a method thereof, and more particularly, to a system for managing and protecting personal information on the Internet and a method thereof that enables a user to manage personal information stored in several ID management servers through one window and to control the use of the personal information.

### BACKGROUND ART

In order to use a large number of web sites existing on the Internet, a user should register as a member of the respective web site by inputting his/her personal information that includes his/her address, phone number, email address, etc. It causes a great inconvenience to the user to register such information with respect to a large number of web sites. Additionally, the personal information registered in the web sites may leak out or be used for other purposes although the corresponding user may not know such use of the personal information.

An Identity management technology for mitigating such inconvenience and guarantee the security of personal information has been proposed. According to this Identity management technology, the personal information is registered in a specified server, and other web sites use the personal information by inquiring of the specified server about the personal information. Accordingly, a user can register his/her personal information only in the Identity management server without the necessity of repeating the registration of his/her personal information in the respective sites one by one. Additionally, the user can control whether a specified web site can inquire about the personal information registered in the Identity management server, and thus he/she can safely manage his/her personal information.

However, it is improper to place only one Identity management server on the Internet. This is because it is very dangerous and may cause an invasion of the respective user's privacy to concentrate all the users' personal information upon one place on the Internet. Consequently, it is common that several Identity management servers exist on the Internet. In this case, however, the respective user should register and manage his/her own information on several Identity management servers and frame a personal information security policy for each of the Identity management servers to cause a great burden on the user.

### DISCLOSURE OF INVENTION

### Technical Problem

Accordingly, the present invention is directed to a system for managing and protecting personal information on the Internet and a method thereof that substantially obviate one or more problems due to limitations and disadvantages of the related art

### Technical Solution

It is an object of the present invention to provide a system for managing and protecting personal information on the Internet and a method thereof that enables a user to manage personal information stored in several ID management servers through one window and to control the use of the personal information in order to perform the management and the use control of the user's information existing on the Internet.

Additional advantages, objects, and features of the present invention will be set forth in part in the description which follows and in part will become apparent to those having ordinary skill in the art upon examination of the following or may be learned from practice of the present invention. The objectives and other advantages of the present invention may be realized and attained by the structure particularly pointed out in the written description and claims hereof as well as the appended drawings.

In order to achieve the above and other objects, there is provided a system for managing and protecting personal information on the Internet, according to the present invention, which comprises at least one ID management server for performing registration of the personal information, and providing the personal information registered by a user to a web server as well as a list of the personal information, the ID management server providing the personal information to the web server in accordance with personal information protection set values including whether to make the personal information public.

In another aspect of the present invention, there is provided a method for managing and protecting personal information on the Internet, which comprises the steps of a) performing registration of the personal information in an ID management server, b) registering a list of the registered personal information in an Identity search server, and c) if the stored personal information is requested, the Identity search server providing the list of the registered personal information, or the ID management server providing the personal information to the web server in accordance with personal information protection set values including whether to make the personal information public.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating the construction of a system for managing personal information on the Internet according to an embodiment of the present invention; and

FIG. 2 is a flowchart illustrating a method for managing personal information on the Internet according to an embodiment of the present invention.

### BEST MODE FOR CARRYING OUT THE INVENTION

The system for managing and protecting personal information on the Internet and a method thereof according to the preferred embodiment of the present invention will now be explained in detail with reference to the accompanying drawings.

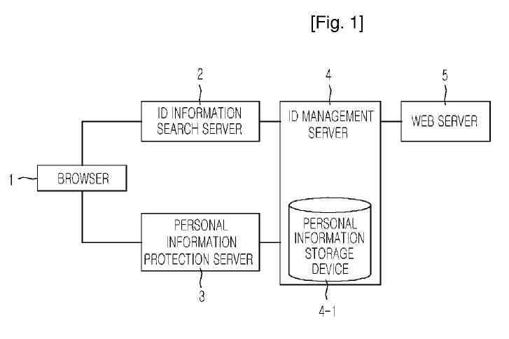

FIG. 1 is a block diagram illustrating the construction of a system for managing personal information on the Internet according to an embodiment of the present invention.

Referring to FIG. 1, the system for managing and protecting personal information on the Internet proposed according to the present invention includes an Identity search server 2, a personal information protection server 3, and an ID management server 4, and operates in association with the existing browser 1 and a web server 5.

The ID management server 4 stores personal information input by users in a personal information storage device 4-1, and provides the stored personal information to a web server if needed. The ID management server 4 also registers a list of the personal information registered by the users in the Identity search server 2. The ID management server 4 is connected to a plurality of web servers 5 to provide the personal information of the users. Meanwhile, a plurality of ID management servers 4 may be provided in the system.

The Identity search server 2 performs a function of searching which information of the users are stored in which ID management server 4 by providing the list of the personal information provided from the ID management server 4. In the case in which plural ID management servers exist in the system, the respective ID management servers may store different kinds of personal information with respect to one user. For example, the ID management server in the Office of Military Manpower Administration may store military affairs information while the ID management server in the Exit and Entry Control Bureau may store immigration information. The Identity search server 2 serves to store and provide the list of such information to the users. The browser 1 is used as a means for searching for the user's Identity from the Identity search server 2. The user grasps which information of the user is stored in which ID management server 4 through the information provided from the Identity search server 2, and then manages his/her own personal information stored in the corresponding ID management server 4 by accessing the ID management server 4.

The personal information protection server 3 is a device that judges whether to provide the user's specified personal information stored in the ID management server 4 to the web server 5. If the web server 5 requests specified personal information of a specified user, the ID management server 4 inquires of the personal information protection server 3 whether to provide the requested information to the personal information protection server 3. The personal information protection server 3 stores preset personal information protection set values. Various kinds of user information may dispersedly be stored in several ID management servers 4. The personal information protection set values should be designated with respect to the list of all the personal information dispersedly stored in several ID management servers 4. The list of all the personal information is brought from the Identity search server 2. The personal information protection server 3 responds to the inquiry of the ID management server 4 on the basis of the personal information protection set values. The ID management server 4 transmits specified personal information to the web server 5 according to the response of the personal information protection server 3. The users' personal information protection set values are stored in the personal information protection server 3 through the users's manipulation of the browser 1.

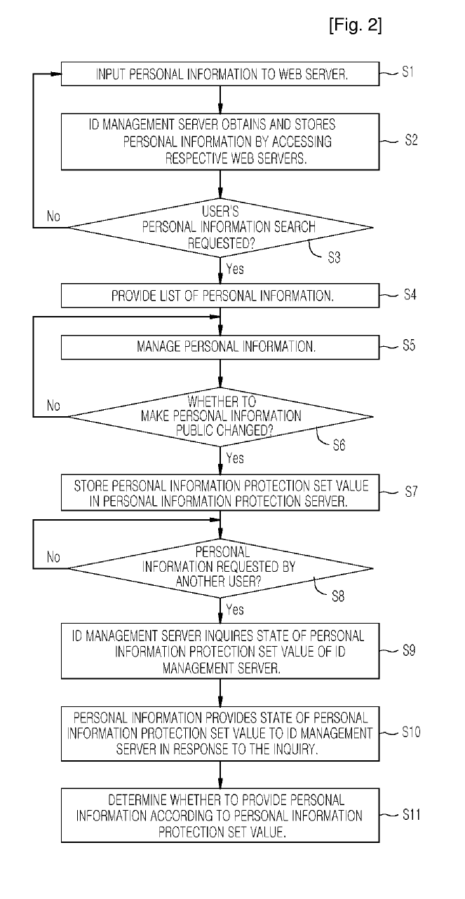

Now, the method for managing and protecting personal information on the Internet as constructed above according to the present invention will be explained with reference to FIG. 2.

FIG. 2 is a flowchart illustrating the method for managing personal information on the Internet according to an embodiment of the present invention. Referring to FIG. 2, as the user registers the personal information in the ID management server 4, the personal information is stored in the personal information storage device 4-1 (step S1). The ID management server 4 registers the list of the personal information registered by the user in the Identity search server 2 (step S2).

If the user requests a personal information search through the browser to manage his/her own personal information (step S3), the Identity search server 2 provides the list of the registered personal information (step S4). Accordingly, the user can confirm the personal information and correct the items subject to management (step S5).

At that time, if the user changes the personal information protection set value, for example, if the user makes the personal information public in managing the personal information (step S6), the changed personal information protection set value is stored in the personal information protection server (step S7).

Meanwhile, if another user requests the personal information of the user (step S8), the ID management server inquires the state of the personal information protection set value of the personal information protection server (step S9). Then, the personal information protection server responds the state of the personal information protection set value to the ID management server (step S10). Whether to provide the personal information is determined according to the personal information protection set value (step S11)

The method according to the present invention as described above can be implemented by a program and stored in a computer-readable recording medium (such as a CD ROM, RAM, ROM, floppy disc, hard disc, optomagnetic disc, etc.). This process can be easily performed by an ordinary skilled in the art that the present invention belongs to, and thus the detailed explanation thereof will be omitted.

As described above, according to the system for managing and protecting personal information on the Internet and the method thereof according to the present invention, personal information are stored in ID management servers that are managed through an Identity search server, and thus a user can manage his/her own personal information in one place to cause convenience in use. Additionally, the system and method according to the present invention can effectively control the access of the personal information and thus the user's privacy can be protected.

While the present invention has been described and illustrated herein with reference to the preferred embodiment thereof, it will be understood by those skilled in the art that various changes and modifications may be made to the invention without departing from the spirit and scope of the invention, which is defined in the appended claims.

1. A system for managing and protecting personal information on the Internet, the system comprising at least one ID management server for performing registration of the personal information, and providing the personal information registered by a user to a web server as well as a list of the personal information, the ID management server providing the personal information to the web server in accordance with personal information protection set values including whether to make the personal information public.

2. The system as claimed in claim 1, wherein the ID management server comprises a personal information storage device for storing the personal information to be provided to the web server.

3. The system as claimed in claim 1, further comprising an Identity search server, connected to the ID management server, for storing the list of the personal information stored in the respective ID management server and providing the corresponding list of the personal information in response to a request of a user terminal.

4. The system as claimed in claim 1, further comprising a personal information protection server for storing the personal information protection set values and providing the personal information protection set values to the ID management server if the personal information is requested.

5. A method for managing and protecting personal information on the Internet, the method comprising the steps of:
a) performing registration of the personal information in an ID management server;
b) registering a list of the registered personal information in an Identity search server; and
c) if the stored personal information is requested, the Identity search server providing the list of the registered personal information, or the ID management server providing the personal information to the web server in accordance with personal information protection set values including whether to make the personal information public.

6. The method as claimed in claim 5, wherein in order to manage the personal information, the step c) comprises the steps of:
requesting a search for the personal information to the Identity search server; and integratedly providing the list of the personal information by searching for the personal information registered in the Identity search server.

7. The method as claimed in claim 6, further comprising the step of performing a management including a correction with respect to the provided personal information.

8. The method as claimed in claim 5, further comprising the step of changing the personal information protection set value and storing the changed personal information protection set value in the personal information protection server before the step b) is performed.

9. The method as claimed in claim 5, wherein at the step b), the providing of the personal information corresponding to the personal information protection set value is performed by the steps of:
the ID management server grasping a state of the personal information protection set value in response to the request for the personal information; and
controlling the providing of the personal information according to the personal information protection set value.
